(19) United States
(12) Patent Application Publication
(10) Pub. No.: US 2017/0181418 A1
(43) Pub. Date: Jun. 29, 2017

(54) MOUNTING ASSEMBLY FOR A FISHING REEL

(71) Applicant: Jason TEELOW, Brisbane (AU)

(72) Inventor: Jason TEELOW, Brisbane (AU)

(21) Appl. No.: 15/235,393

(22) Filed: Aug. 12, 2016

(30) Foreign Application Priority Data
Dec. 23, 2015 (AU) 2015275331

(51) Int. Cl. A01K 87/06

(52) U.S. Cl. CPC A01K 87/06

(57) ABSTRACT

A mounting assembly for a fishing reel, the assembly including a mounting rod, a reel mounting portion rotatably associated with the mounting rod and an elongate arm extending in the same plane but opposite direction to the reel mounting portion and having at least one line guide.

### TECHNICAL FIELD

The present invention relates to fishing generally and more particularly to mounting a fishing reel relative to a surface for use.

### BACKGROUND ART

A fishing reel is a device used for the deployment and retrieval of a fishing line using a spool mounted on an axle. Fishing reels are traditionally used in the recreational sport of angling. They are most often used in conjunction with a fishing rod, though some specialized reels are mounted directly to boat gunwales or transoms.

It is an object of the present invention to provide a useful alternative to a mounting assembly to mount a fishing reel relative to a surface which allows a user to use a fishing reel without a fishing rod.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a mounting assembly for a fishing reel, which may at least partially overcome at least one of the abovementioned disadvantages or provide the consumer with a useful or commercial choice.

With the foregoing in view, the present invention in one form, resides broadly in a mounting assembly for a fishing reel, the assembly including a mounting rod, a reel mounting portion rotatably associated with the mounting rod and an elongate arm extending in the same plane but opposite direction to the reel mounting portion and having at least one line guide.

The mounting assembly of the present invention is preferably used for mounting a fishing reel relative to a surface. The surface may be part of a boat, jetty or any other surface adjacent the body of water.

Typically, the mounting assembly is mounted relative to the surface using the mounting rod. Normally, this is achieved through insertion of the mounting rod into an opening or hole, into or through the surface. However, the mounting rod may be fixed to the surface. The mounting rod may be fixed to or relative to the surface, into the opening or hole or it may remain unfixed and simply rest through its own weight.

The mounting assembly is used to mount a fishing reel. The fishing reel will normally be of the type that would otherwise be mounted to a fishing rod. Any type of fishing reel may be used with the mounting assembly of the present invention for example, an overhead or “baitcaster” reel, a spinning reel, a centrepin reel, a spin cast reel or and underspin reel. The common features of all these types of fishing reels is that they typically possess a reel foot which is mounted on a support arm extending from the body of the fishing reel which allows the reel to be fixed to a rod. The reel foot is typically a unitary member extending substantially in the same direction as the line from the fishing reel and normally, the reel foot tapers in thickness at either end.

The mounting rod of the mounting assembly of the present invention is typically elongate and may be manufactured from a single or multiple parts. Preferably, the mounting rod is a two-part component interconnected using a pivot attachment. Preferably, the lower rod portion is used to mount the mounting rod and the upper rod portion is used to adjust the angle of use.

The pivot attachment preferred includes a tongue on one end of one mounting rod portion which is received in a groove in one end of the other mounting rod portion. Normally, the groove will be defined between two spaced apart end portions.

Normally, both of the spaced apart end portions and the tongue will have an opening therethrough in order to receive a fastener used to clamp the tongue in the groove to set the angle of the mounting rod portions relative to other. Typically, a knob or similar is used to tighten and loosen the fastener which will normally be threaded.

The tongue and/or the groove may be ridged and the respective ridges may interengage to assist with maintaining the angle between the mounting rod portions, particularly when under what may be a severe load when a fish is being caught.

Preferably, the low end of the lower rod portion may be provided with a groove or slot in order to assist with mounting the mounting rod relative to the surface.

The reel mounting portion is rotatably associated with the mounting rod. The reel mounting portion is used to mount the reel relative to the mounting assembly and will typically have the form of an elongate arm.

The reel mounting portion typically has a reel seat and one or more reel seat mounts. These reel seat mounts will typically be adjustable in order to receive and mount reels of different types and configurations. Any type of reel seat mounts may be used.

Common reel seats typically feature a pair of adjustable seat mounts. One common variety utilizes screw-type clamps. Adjustable seat mounts each have a collar. Generally, the reel is attached by inserting a leading edge of the reel foot into an adjustable seat mount between the collar and the surface of reel seat. The adjustable seat mount is then advanced along the length of the reel mounting portion using a screwing motion until it locks the reel foot into place. Normally, the reel mounting portion has male threads along the seat, and female threads are used on the inside surface of the adjustable seat mounts. The adjustable seat mounts clamp the reel foot firmly to the reel mounting portion so that reel cannot move up or down or rotate angularly about the reel mounting portion.

Although screw-type clamps are most common, adjustable seat mounts may assume many different configurations. An alternative and preferred configuration is to have one fixed seat mount and one movable seat mount.

The seat mounts may have a collar shaped to receive the reel foot and internally threaded screw member in order to move and position the collar.

The reel mounting portion is preferably attached to the mounting rod in order to define an angle therebetween. Typically, the angle is more than 90° but less than 180°. Typically, the reel mounting portion will extend rearwardly with the elongate arm having a line guide extending forwardly in use.

Preferably, the reel mounting portion will be integrally formed with the elongate arm having the line guide. Preferably, an angle is maintained between the reel mounting portion and the elongate arm which is typically more than 90° but less than 180°.

The length of the reel mounting portion is preferably defined by the length of the reel seat. Normally, a number of configurations will be available for different sized reels. Alternatively, a single length will be provided with the adjustable reel seat mounts used to receive reels of different sizes.

As mentioned previously, there is a rotatable mount provided between the reel mounting portion and the mounting rod. There are many configurations which can be used to achieve this end but preferably, a circumferential flange is provided on an upper end of the upper mounting rod portion. A circumferential slot or similar (for example a radially extending flange) can be provided on the reel mounting portion with an annular fixing member seated in the slot (or over the radially extending flange). The annular fixing member is preferably attached to the flange of the upper mounting rod portion in order to allow rotation of the reel mounting portion within the annular fixing member.

It is further preferred that the reel mounting portion is rotatable relative to the mounting rod about a substantially horizontal axis as well in order to allow tilting of the reel mounting portion from side to side as well as rotation. This can be achieved by providing a ball or swivel joint for example.

The rotation and tilting of the reel mounting portion may be free or a fixing mechanism may be provided for one or both in order to temporarily fix the position of the reel mounting portion relative to the mounting rod.

The reel mounting portion is associated with an elongate arm having a line guide. The reel mounting portion may be integrally formed with the elongate arm or the two may be separate components attached together.

At least one line guide is provided and typically at least at the end of the elongate arm. Any form of line guide may be provided.

The elongate arm may be rigid or partially resilient.

A handle assembly may be provided on the rear of the reel mounting portion in order to manipulate or move the reel mounting portion. Where provided, a handle assembly may be used during retrieval of the line. The reel mounting portion may be reciprocated during retrieval of the line particularly when catching a fish in order to decrease fatigue by allowing the line to be retrieved more easily.

Any of the features described herein can be combined in any combination with any one or more of the other features described herein within the scope of the invention.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a side view of a mounting assembly for a fishing reel according to a preferred embodiment.

FIG. 2 is an exploded side view of the mounting assembly illustrated in FIG. 1.

FIG. 2A is a detailed view of the line guide illustrated in FIG. 2.

FIG. 3 is an illustration of the mounting assembly illustrated in FIG. 1 in use.

FIG. 4 is a view from the front of the mounting assembly illustrated in FIG. 1.

FIG. 5 is a view from the front of the mounting assembly illustrated in FIG. 1 showing the movement of the various components.

FIG. 6 is a view from the side of the mounting assembly illustrated in FIG. 1 showing the rotation of the mounting rod.

### DESCRIPTION OF EMBODIMENTS

According to a particularly preferred embodiment, a mounting assembly for a fishing reel is provided.

The mounting assembly 10 for a fishing reel 11 illustrated in the Figures includes a multipart mounting rod 12, a reel mounting portion 13 rotatably associated with the mounting rod 12 and an elongate arm 14 extending in the same plane but opposite direction to the reel mounting portion 13 and having a line guide 15.

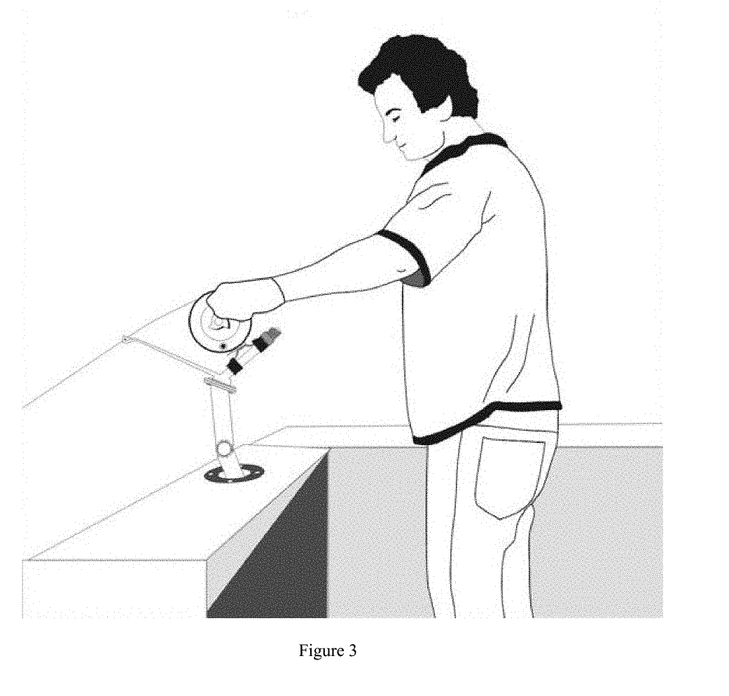

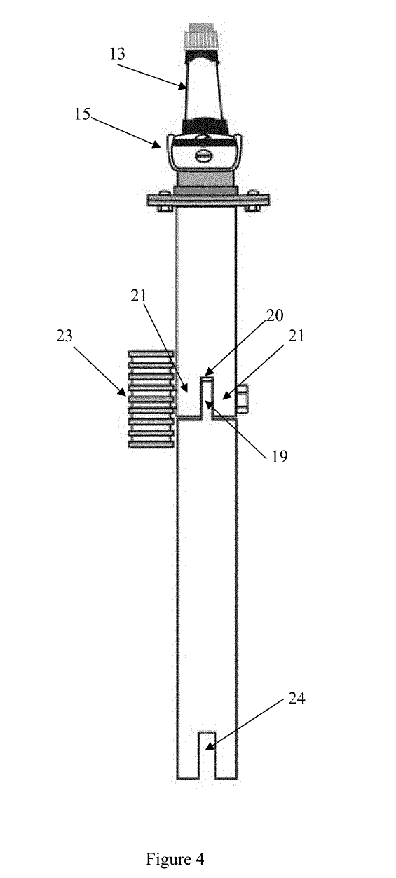

The mounting assembly of the present invention is preferably used for mounting a fishing reel relative to a surface and one use is illustrated in FIG. 3 where the mounting assembly is used on a boat gunwhale through insertion of the mounting rod into an opening or hole into or through the gunwhale.

The mounting rod 12 of the illustrated embodiment is elongate and manufactured from two portions, namely an upper rod portion 16 and a lower rod portion 17 interconnected using a pivot attachment 18. The lower rod portion 17 is used to mount the reel mounting portion 13 and the upper rod portion 16 is used to adjust the angle of use.

The pivot attachment 18 of the illustrated embodiment includes a tongue 19 on the upper end of the lower rod portion 17 which is received in a groove 20 in the lower end of the upper rod portion 16. The groove 20 is defined between two spaced apart end portions 21.

Both of the spaced apart end portions 21 and the tongue 19 have an opening 22 therethrough in order to receive a fastener used to clamp the tongue 19 in the groove 20 to set the angle of the mounting rod portions relative to other. Typically, a knob 23 is used to tighten and loosen the fastener which is normally threaded.

The lower end of the lower rod portion 17 is provided with a groove or slot 24 in order to assist with mounting the mounting rod in the illustrated embodiment.

The reel mounting portion 13 is rotatably associated with the mounting rod 12. The reel mounting portion 13 is used to mount the fishing reel 11 relative to the mounting assembly 10 and in the illustrated embodiment, has the form of an elongate arm.

The reel mounting portion 13 has a reel seat 25 and a pair of reel seat mounts 26, one fixed seat mount 26A and one movable seat mount 26B.

Both seat mounts have a collar 27. Generally, the reel is attached by inserting a leading edge of the reel foot into the lower fixed seat mount 26A between the collar 27 and the surface of the reel mounting portion 13. The collar 27 of the adjustable seat mount 26B is then advanced along the length of the reel mounting portion 13 by a screwing motion of a locking nut 28 until it locks the reel foot into place. The reel mounting portion 13 has a male thread 29 along the seat, and female threads are used on the inside surface of the locking nut 28. One or more washers 30 are also used.

According to the illustrated embodiment, the reel mounting portion 13 is attached to the mounting rod 12 in order to define an angle of more than 90° but less than 180° therebetween. In use, the reel mounting portion 13 extends rearwardly with the elongate arm 14 having the line guide 15 extending forwardly.

The reel mounting portion 13 of the preferred embodiment is integrally formed with the elongate arm 14 having the line guide 15. An angle of more than 90° but less than 180° is maintained between the reel mounting portion 13 and the elongate arm 14.

As mentioned previously, there is a rotatable mount 36 provided between the reel mounting portion 13 and the mounting rod 14. A circumferential flange 31 is provided on an upper end of the upper mounting rod portion 16. A circumferential slot 32 is provided on the reel mounting portion 13 with an annular fixing member 33 seated in the slot 32. The annular fixing member 33 is attached using nuts 34 and bolts 35 to the flange 31 of the upper mounting rod portion 16 in order to allow rotation of the reel mounting portion 13 within the annular fixing member 33.

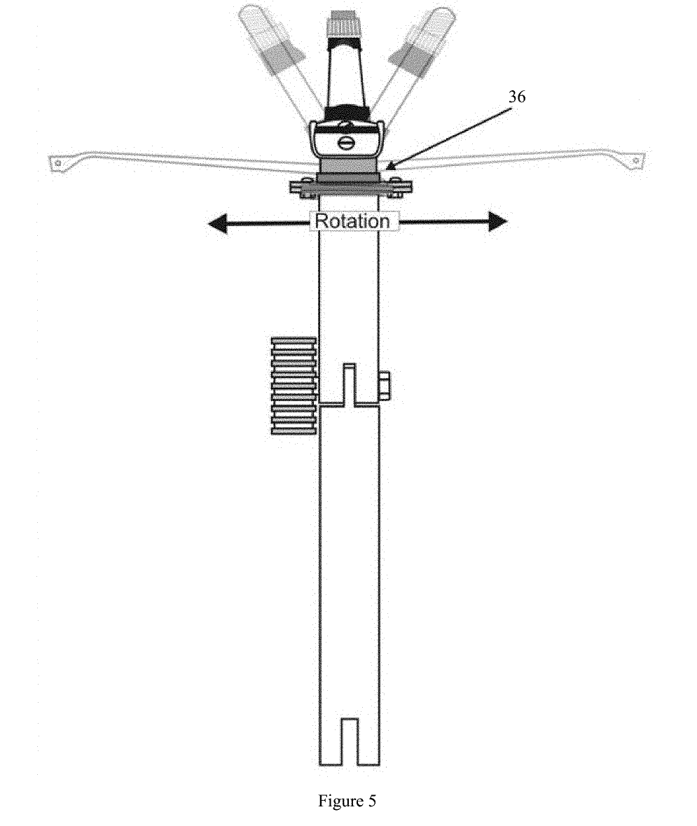

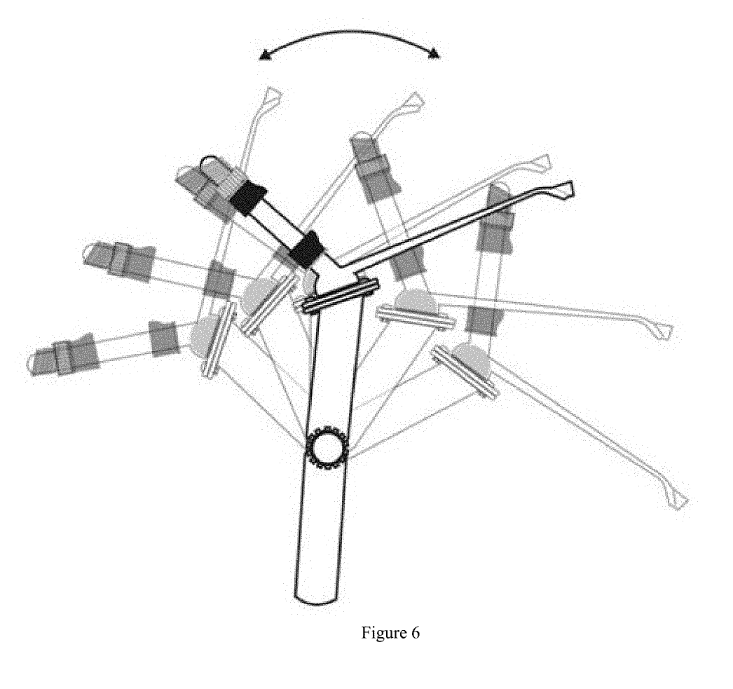

The reel mounting portion 13 is rotatable relative to the mounting rod 12 about a substantially horizontal axis as well in order to allow tilting of the reel mounting portion 13 from side to side as well as rotation as illustrated in FIG. 5. This can be achieved by providing a ball or swivel joint for example.

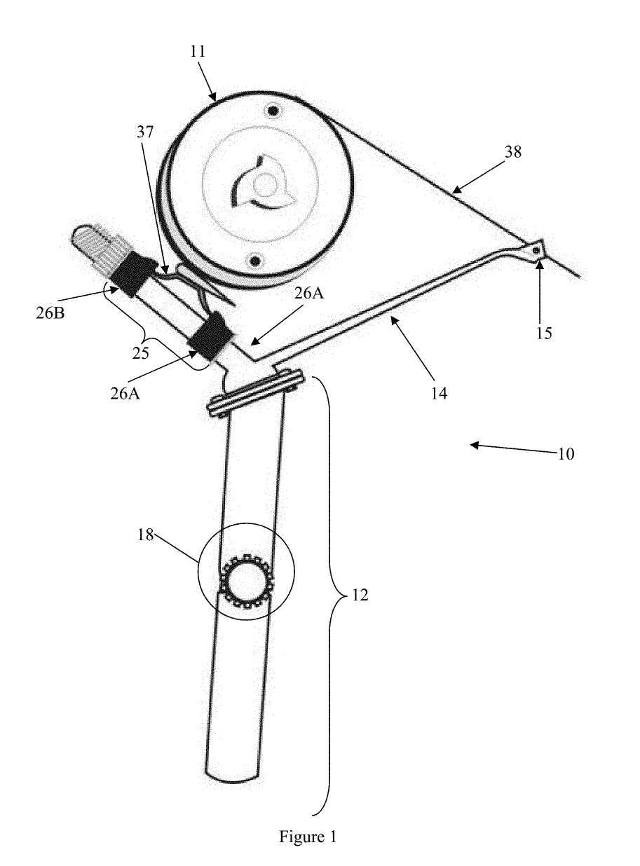

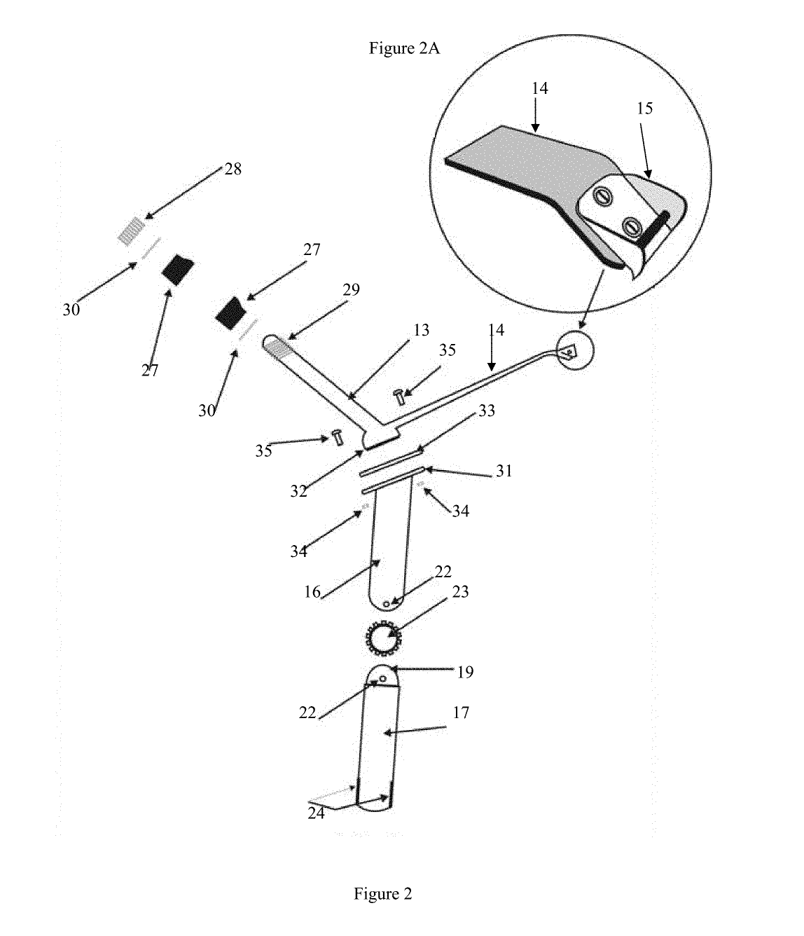

The reel mounting portion 13 is associated with an elongate arm 14 having a line guide 15. At least one line guide is provided and typically at the end of the elongate arm 14 as illustrated in FIG. 1.

The mounting assembly is used to mount a fishing reel. The fishing reels will normally possess a reel foot. As illustrated in FIG. 1, the reel foot 37 is typically a unitary member extending substantially in the same direction as the line 38 from the fishing reel 11 and normally, the reel foot 37 tapers in thickness at either end.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A mounting assembly for a fishing reel, the assembly including a mounting rod, a reel mounting portion rotatably associated with the mounting rod and an elongate arm extending in the same plane but opposite direction to the reel mounting portion and having at least one line guide.

2. A mounting assembly for a fishing reel as claimed in claim 1 wherein the mounting assembly is mounted relative to a surface using the mounting rod by insertion of the mounting rod into an opening, into or through the surface.

3. A mounting assembly for a fishing reel as claimed in claim 1 wherein the mounting rod is elongate and is a two-part component interconnected using a pivot attachment.

4. A mounting assembly for a fishing reel as claimed in claim 3 wherein the pivot attachment includes a tongue on one end of one mounting rod portion which is received in a groove in one end of the other mounting rod portion, the groove defined between two spaced apart end portions.

5. A mounting assembly for a fishing reel as claimed in claim 4 wherein both of the spaced apart end portions and the tongue have an opening therethrough in order to receive a fastener used to clamp the tongue in the groove to set the angle of the mounting rod portions relative to other.

6. A mounting assembly for a fishing reel as claimed in claim 4 wherein the tongue and/or the groove is ridged and the respective ridges interengage to assist with maintaining the angle between the mounting rod portions.

7. A mounting assembly for a fishing reel as claimed in claim 1 wherein a lower end of the mounting rod is provided with a groove or slot in order to assist with mounting the mounting rod relative to a surface.

8. A mounting assembly for a fishing reel as claimed in claim 1 wherein the reel mounting portion is rotatably associated with the mounting rod.

9. A mounting assembly for a fishing reel as claimed in claim 1 wherein the reel mounting portion is configured as an elongate arm with a reel seat and one or more adjustable reel seat mounts to receive and mount reels of different types and configurations.

10. A mounting assembly for a fishing reel as claimed in claim 9 wherein the reel mounting portion has male threads along the reel seat, and female threads are used on an inside surface of the adjustable seat mounts to clamp the reel foot firmly to the reel mounting portion so that reel cannot move up or down or rotate angularly about the reel mounting portion.

11. A mounting assembly for a fishing reel as claimed in claim 9 wherein the reel seat mounts include a collar shaped to receive a reel foot and internally threaded screw member in order to move and position the collar.

12. A mounting assembly for a fishing reel as claimed in claim 1 wherein the reel mounting portion is attached to the mounting rod in order to define an angle more than 90° but less than 180° therebetween.

13. A mounting assembly for a fishing reel as claimed in claim 1 wherein the reel mounting portion will extend from an attachment portion in one direction and an elongate arm having a line guide extending in an opposite direction in use.

14. A mounting assembly for a fishing reel as claimed in claim 13 wherein the reel mounting portion is integrally formed with the elongate arm having the line guide.

15. A mounting assembly for a fishing reel as claimed in claim 13 wherein an angle is maintained between the reel mounting portion and the elongate arm which is more than 90° but less than 180°.

16. A mounting assembly for a fishing reel as claimed in claim 1 wherein rotation of the reel mounting portion can be fixed using a fixing mechanism provided to temporarily fix the position of the reel mounting portion relative to the mounting rod.

17. A mounting assembly for a fishing reel as claimed in claim 1 further including at least one line guide provided on an elongate arm substantially opposed to the reel mounting portion.

18. A mounting assembly for a fishing reel as claimed in claim 17 wherein the elongate arm is partially resilient.

19. A mounting assembly for a fishing reel as claimed in claim 1 further including a handle assembly provided on the reel mounting portion in order to manipulate or move the reel mounting portion.
